(19) United States
(12) Patent Application Publication
(10) Pub. No.: US 2010/0169146 A1
(43) Pub. Date: Jul. 1, 2010

(54) AUTOMATED SCHEDULING OF TO-DO ITEMS WITHIN A CALENDAR

(75) Inventors: Ronan Hoyne, Dublin (IE); Declan Joyce, Gort (IE); Ronan Redican, Dublin (IE); Carol S. Zimmet, Boxborough, MA (US)

Correspondence Address: Cuenot, Forsythe & Kim, LLC, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 12/346,161

(22) Filed: Dec. 30, 2008

(51) Int. Cl. G06Q 10/00

(52) U.S. Cl. 705/9

(57) ABSTRACT

A computer-implemented method of task scheduling can include receiving an input from a user, wherein the input specifies a task comprising a due date and determining whether the task includes supplemental scheduling information. When the task does not include supplemental scheduling information, a first calendar event corresponding to the task can be created and stored within memory within a calendar of the user scheduled on the date. When the task does specify supplemental scheduling information, at least a first calendar event corresponding to the task can be created and stored, within memory, within a calendar of the user scheduled according to the date and the supplemental scheduling information. Calendar events created for a task that conflict with other calendar events can be dynamically rescheduled.

### BACKGROUND

The embodiments of the present invention relate to personal information management and, more particularly, to automated task scheduling. Personal information management (PIM) tools encompass a variety of applications designed to simplify organizing and storing a myriad of information and interactions related to a user. The information and interactions can include meetings, appointments, projects, tasks, contact information, medical and/or financial records, documents, files, and the like associated with the user. PIM tools, such as, address book applications, calendar applications, instant messaging (IM) applications, and project management applications seek to implement related PIM methodologies.

When dealing with task management, one type of PIM application, to-do list applications, can provide a structured approach to creating a task list. To-do list applications can store a list of tasks, along with a due date for each task. In this manner, tasks can be tracked and checked off as each task is completed. Tasks can be grouped into projects or shared with other users accessing the to-do list. With some to-do list application a user can access stored task lists via the Intranet or a shared network, e.g., a mobile phone network, providing access from remote locations.

### BRIEF SUMMARY OF THE INVENTION

The embodiments disclosed herein relate to personal information management (PIM). One embodiment of the present invention can include a computer-implemented method of task scheduling. The method can include receiving an input from a user, wherein the input specifies a task including a date and determining whether the task includes supplemental scheduling information. The method further can include, when the task does not include supplemental scheduling information, creating and storing, within memory, a first calendar event corresponding to the task within a calendar of the user scheduled on the date, and when the task does specify supplemental scheduling information, creating and storing, within memory, at least a first calendar event corresponding to the task within a calendar of the user scheduled according to the date and the supplemental scheduling information.

Another embodiment of the present invention can include a system for performing task scheduling. The system can include a memory including computer-usable program code and a processor, executing the computer-usable program code, wherein the processor receives an input from a user, wherein the input specifies a task including a date. The processor further can determine whether the task includes supplemental scheduling information. When the task does not include supplemental scheduling information, the processor can create and store, within memory, a first calendar event corresponding to the task within a calendar of the user scheduled on the date. When the task does specify supplemental scheduling information, the processor can create and store, within memory, at least a first calendar event corresponding to the task within a calendar of the user scheduled according to the date and the supplemental scheduling information.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for automated task scheduling in accordance with one embodiment of the present invention.

FIG. 2 is a first pictorial view illustrating a user interface for task scheduling in accordance with another embodiment of the present invention.

FIG. 3 is a second pictorial view illustrating a calendar in which tasks are scheduled in accordance with another embodiment of the present invention.

FIG. 4 is a third pictorial view illustrating a calendar in which tasks are scheduled in accordance with another embodiment of the present invention.

FIG. 5 is a first flow chart illustrating a method of scheduling tasks within a calendar in accordance with another embodiment of the present invention.

FIG. 6 is a second flow chart illustrating a method of scheduling tasks within a calendar in accordance with another embodiment of the present invention.

### DETAILED DESCRIPTION OF THE INVENTION

As will be appreciated by one skilled in the art, embodiments of the present invention may take the form of a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, an embodiment of the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example, but is not limited to, an electronic, magnetic, optical, magneto-optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The embodiments disclosed within this specification relate to task scheduling. More particularly, the embodiments relate to scheduling to-do list items, or tasks, within a calendar corresponding to a user. Typical to-do list applications provide a variety of features which enhance the ability of a user to store and manage tasks. To-do applications, however, provide no mechanism to schedule and manage the allocation of time necessary to process or perform a task. Similarly, calendar applications allow the creation and storage of tasks, but fail to schedule and display tasks with respect to the calendar corresponding to the user.

In accordance with the inventive arrangements disclosed herein, a user input can be received specifying a date and scheduling requirements for a task, e.g., task start and/or end date, hours to complete the task, time per day to devote to the task, or the like. Using the time and scheduling requirements for the task, available slots of time to perform the task can be determined within a calendar corresponding to the user. Calendar entries for the task can be scheduled within the available slots of time based upon the scheduling requirements. Each calendar entry for the task can be displayed within the calendar in a manner that identifies the calendar entry as being related to the task.

In addition, upon the user accepting an invitation to an event, e.g., a meeting request, that conflicts with a calendar entry scheduled for a task, the event can replace the calendar entry corresponding to the task in the conflicting slot of time. Subsequently, an available slot of time can be identified. A calendar entry for the task can be scheduled, or rescheduled as the case may be, within the newly determined and available slot of time.

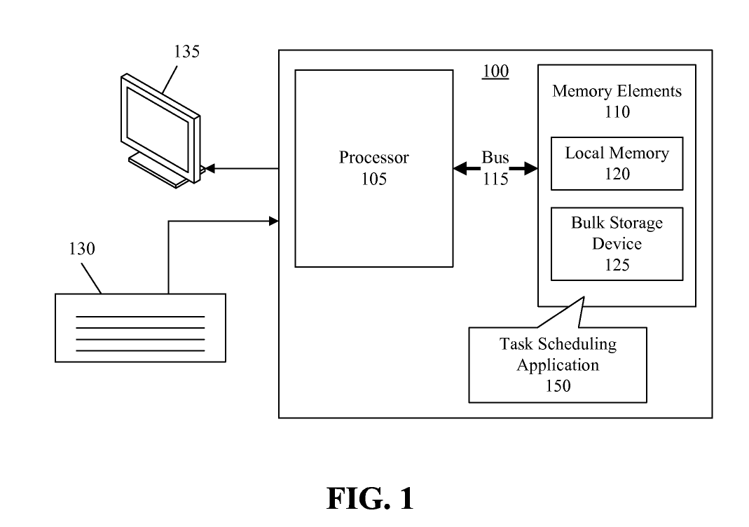

FIG. 1 is a block diagram illustrating a system 100 for automated task scheduling in accordance with one embodiment of the present invention. System 100 can provide scheduling capabilities for to-do list items, or tasks, within a calendar corresponding to a user. Within this specification, the term “calendar,” unless otherwise explicitly indicated or indicated by the context in which the term is used, will refer to the calendar corresponding to the user that is specifying the task.

System 100 can be implemented as a data processing system, e.g., a computer, that can execute computer-usable program code. Accordingly, system 100 can include at least one processor 105 coupled directly or indirectly to memory elements denoted as memory 110 through a system bus 115. Memory 110 can include one or more physical memory devices or elements. The elements can include, for example, local memory 120 employed during actual execution of the program code, e.g., random access memory (RAM), one or more bulk storage devices 125, e.g., a hard drive or other persistent data storage device, and cache memories (not shown) which provide temporary storage of at least some program code in order to reduce the number of times code must be retrieved from bulk storage during execution.

Input/output (I/O) devices such as a keyboard 130, a display 135, and a pointing device (not shown) optionally can be coupled to system 100 as well as one or more other I/O devices. The I/O devices can be coupled to system 100 either directly or through intervening I/O controllers. Network adapters also can be coupled to system 100 to enable system 100 to become coupled to other data processing systems or remote printers or storage devices through intervening private or public networks. Modems, cable modems, and Ethernet cards are just a few of the currently available types of network adapters.

Processor 105, executing task scheduling application 150, can present various user interfaces via display 135 through which the user can input tasks and task scheduling information, present and manage a calendar corresponding to the user, and schedule tasks within the calendar. Processor 105 can receive user inputs prioritizing tasks, and process tasks and task information according to that prioritization. In addition, alerts and notification related to tasks, and task scheduling, can be rendered on display 135 by processor 105.

In operation, processor 105 can execute task scheduling application (application) 150. In one embodiment, application 150 can be implemented as a standalone application providing task management and scheduling capabilities as well as calendar and event management capabilities. In another embodiment, application 150 can be implemented as a plug-in executing within a host application. For example, application 150 can be a plug-in interacting with a calendaring client.

System 100 can receive a user input specifying a task. In one embodiment, responsive to a user input, system 100 can render a task specification interface on display 135 through which the user can input information corresponding to the task. The task can be specified by a task specification which can include a task description, e.g., a task name or reference, as well as a due date for the task. As used within this specification, the term “due date” can refer to a calendar date within the calendar corresponding to the user specifying the task. The due date can be any of a variety of dates associated with a task, e.g., a task start date, a task deadline, a task reminder date, or the like. As such, while the due date can refer to a deadline or completion date for the task, the due date need not be a completion date and may refer to another date associated with the task. Optionally, the user input can include supplemental scheduling information corresponding to the task, which also can be specified as part of the task specification.

As used within this specification, “supplemental scheduling information,” can refer to any information related to a task which can be used to determine and update the scheduling of the task within a calendar corresponding to a user. For example, supplemental scheduling information can include a start and/or end date for the task, one or more day(s) in which work relating to the task is to performed, a total number of hours necessary to complete the task, a number of hours per day to assign to the task, a priority level of the task, or any other information that can contribute to the creation, scheduling, and/or updating of the task.

Upon receiving a user input specifying a task, system 100 can determine whether supplemental scheduling information has been specified for the task. When supplemental scheduling information does not exist for a given task, system 100 can schedule a calendar event for the task according to the task description and the due date for the task. For example, a user can input a task description, “Doctor's appointment,” and a due date, “July 15 at 4:00 p.m.,” to system 100 to specify a task. As the task specification does not contain supplemental scheduling information, system 100 can create a calendar event for July 15 at 4:00 p.m. within the calendar corresponding to the user.

When supplemental scheduling information does exist within the task specification, system 100 can schedule the task within the calendar according to the supplemental scheduling information. During the task scheduling process, system 100 can at least determine a time requirement for each day the task is to be scheduled and identify one or more available slot(s) of time each day for the task within the calendar. As used within this specification, a “slot of time” or “time slot,” can refer to any continuous period of time with a defined start time and end time. Having determined the time requirement for each day and identified one or more available slot(s) of time each day for the task, system 100 can create and store one or more calendar event(s) for the task corresponding to the one or more available slot(s) of time within the calendar.

For example, a task specification can contain supplemental scheduling information. The supplemental scheduling information can define the task as occurring for five days from Monday to Friday. In addition, the supplemental scheduling information can specify one hour in each of the five days to be scheduled for the task. Using the supplemental scheduling information, for each day, system 100 can identify one or more available slot(s) of time which can be devoted to the one hour specified for the task. For each day, system 100 can create one or more calendar event(s) according to the slots of time available for the one hour to be scheduled for the task.

In one embodiment, upon the user specifying a task, responsive to a user input requesting a hold, the scheduling of the task within available slots of time within the calendar can be suspended. At a time subsequent to the hold, responsive to a user input releasing the hold, the task can be scheduled within available slots of time within the calendar. For example, the user may specify a task two weeks prior to a start date for the task. The user, knowing a series of high priority meeting will be scheduled the week prior to the start date of the task, can request a hold on the scheduling of the task until a time subsequent to the scheduling of the high priority meetings. Upon the high priority meetings being scheduled, the user can release the hold. Responsive to the release of the hold, system 100 can schedule one or more calendar events for the task within available slots of time within the calendar of the user.

In another embodiment, system 100 can visually distinguish a calendar event generated from, or associated with, a task from calendar events that are not generated from, or associated with, tasks by altering an appearance of task-related calendar events within the calendar of the user as shown upon a display. For example, calendar events relating to tasks can be presented within the calendar with blue text while all other types of calendar events may be presented with red text. Other identifiers can be used. As such, the embodiments disclosed within this specification are not intended to be limited by the particular visualization technique used.

Subsequent to the scheduling of the task, the user can receive an invitation to an event that conflicts, e.g., occurs at a same time or overlaps, with a calendar event created for the task. Upon the user accepting the invitation, one or more calendar event(s) can be created for the event for which the invitation was accepted that conflict with one or more calendar event(s) created for the task. In that case, system 100 can identify the each conflicting calendar event for the task, identify one or more slot(s) of time available to reschedule the calendar events, and reschedule the calendar events to the identified time slot(s). Rescheduling a calendar event can include, for example, deleting a calendar event and creating a replacement calendar event in a different time slot or simply modifying the date and/or time of an existing calendar event.

System 100 can present, and/or transmit, notifications and/or alerts corresponding to task scheduling and scheduling conflicts. The notifications and/or alerts can be rendered on display 135. In addition, notifications and/or alerts can be transmitted to the user via the Internet, an Intranet or a network connected to system 100, e.g., electronic mail, text message, or the like.

In one embodiment, the user can input a level of priority for each task. The differing levels of priority can influence a variety of functions within system 100 including the scheduling of tasks, rescheduling task-event conflicts, task notifications and alerts, and appearances of calendar entries within the calendar. For example, system 100 can determine the order of task scheduling for two or more tasks according to the priority level of each task.

It should be noted that unlike meetings or other calendar events, subsequent to scheduling, tasks are not rendered as static calendar entries within the calendar. Tasks can retain a presence within a task list and may be dynamically rescheduled within the calendar responsive to the acceptance of conflicting calendar events that are not tasks. Further, supplemental scheduling information may not definitively describe a time slot within which the task should be scheduled, e.g., not specify a start time and an end time as is the case with a calendar event. Rather, the data can be scheduling guidelines, e.g., a start and end date, total time required for task completion, or the like, through which time slots assigned to the task can be dynamically scheduled and altered. In addition, the rescheduling of the task can be influenced by the priority level of a task relative to the priority level of each other task.

In another aspect, since the task may still exist independently of the calendar events scheduled for the task, any update to the task specification, e.g., the supplemental scheduling data, can cause system 100 to dynamically update any scheduled calendar events for the task. That is, such calendar events can be deleted, rescheduled, or new calendar events created to accommodate any changes to the supplemental scheduling information. This process can be dynamic in nature as the task specification is changed.

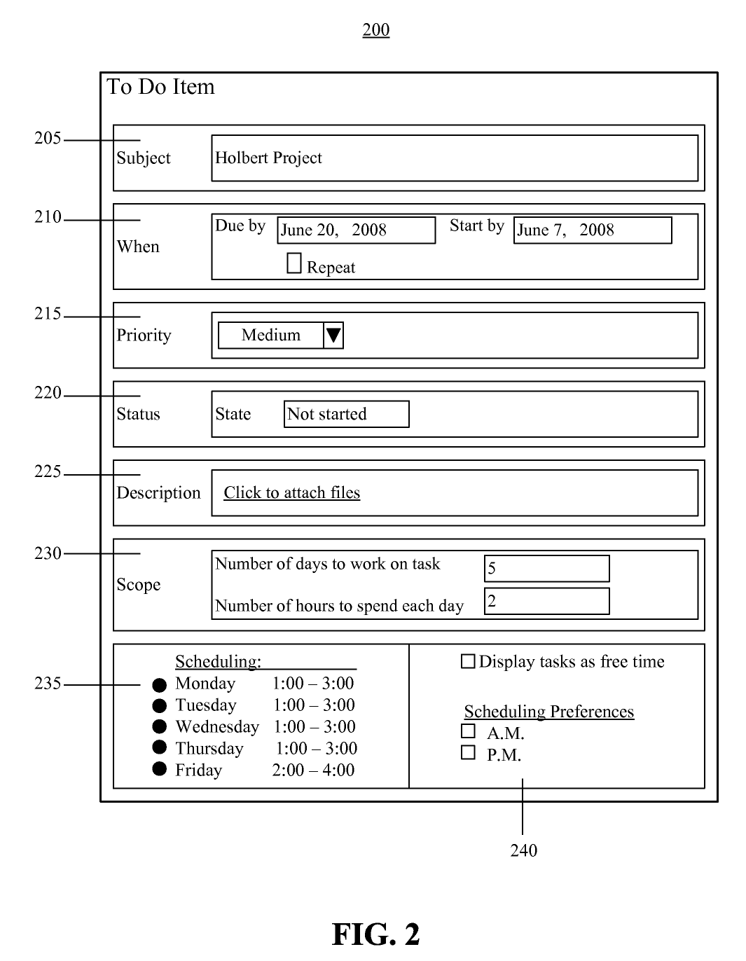

FIG. 2 is a first pictorial view illustrating a user interface 200 for task scheduling in accordance with another embodiment of the present invention. A system, as described with reference to FIG. 1, can render user interface 200 upon a display communicatively linked to the system. FIG. 2 illustrates a case where a user input has invoked the presentation of interface 200. Through user interface 200, the user can schedule a task within a calendar corresponding to the user. User interface 200 can include subject field 205, date field 210, priority field 215, status field 220, description field 225, and scope field 230.

In one embodiment, user interface 200 can be invoked responsive to a user input to a user interface graphically presenting a calendar corresponding to the user. For example, user interface 200 can be rendered responsive to the user selecting a key, a combination of keys, or providing pointer input. Additionally, the user can navigate, using the keyboard, to a time slot within the graphical representation of the calendar. A subsequent user input can invoke user interface 200 with the date field 210 pre-filled with date information for the time slot to which the user navigated. In another embodiment, a cursor associated with a pointing device can be positioned over a time slot of the calendar. A user input specified via the pointing device, while the cursor is positioned over the time slot, can invoke user interface 200 with the date field 210 pre-filled with date information for the time slot under the cursor.

Within subject field 205, the user can input a task name, a task description, a task subject or task type, or any other information that can reference the task for the user. For example, the user can input a meeting, e.g., design meeting, a task type, e.g., haircut appointment, or a task description, e.g., “meet John for lunch.” Within date field 210, the user can input dates defining the beginning and end dates of the project. As shown a repeat box can be checked if the task is a recurring task, e.g., one that must be performed in the future periodically or from time-to-time.

In one embodiment, responsive to the user only entering information within subject field 205 and a task due date in date field 210, thereby providing no supplemental scheduling information, the system can create and store a calendar event on the due date input by the user for the task. That is, the system can create a calendar event within the calendar of the user that corresponds to the task but which is separate from the task that is being defined and created. More particularly, the system will create the task as specified as well as a meeting for the task to aid the user in scheduling time for the task.

Within priority field 215, the user can select a priority level for the task, which can be considered a type of supplemental scheduling information. In one embodiment, a drop down menu can be presented to the user. The drop down menu can include a list of predetermined priority levels for the task from which the user can select a particular priority level for the task. It should be noted that drop down menus with a selection of appropriate predetermined responses for a particular field can be implemented within each of the fields of user interface 200. As such, the use of any particular user interface element to describe aspects of the embodiments described within this specification is not intended to limit the embodiments disclosed.

The use of priority levels for tasks can influence a variety of behaviors of the system. In one embodiment, priority levels of the tasks can influence scheduling of the tasks. For example, a high priority task will be scheduled before a low priority task in the calendar. In another example, an event invitation may be declined when it conflicts with a time slot assigned to a high priority task.

In another embodiment, the priority level can determine whether an alert or notice is issued to a user responsive to an action by the system. For example, a meeting invitation can be received by the user for a meeting that is scheduled to occur during a time slot already reserved for a high priority task. Subsequent to the user accepting the meeting invitation, the system can notify the user that a high priority task will be rescheduled as a result of accepting the meeting. The notification can be sent only when a conflict is detected for a meeting scheduled for a task and that meeting is for tasks exceeding a particular priority threshold level.

Within status field 220, the user can input a description of the present state of the task, which is another type of supplemental scheduling information. For example, the user can input the task description as “just started” or “near completion.” The state description can provide other users viewing the calendar an awareness of the progress level in completing a task. Within description field 225, the user can attach documents or files providing information describing the task, status reports on the task, data related to the task, or any other information, corresponding to the task.

Within scope field 230, the user can input another form of supplemental information such as a number of days and/or a number of hours per day to devote to the task being defined. For example, the user can define the scope of the task as requiring five days with two hours devoted each day to the task. Using this supplemental scheduling information, the system can identify two hours of available time for the user within each of five days between the specified start date and the due date. The system can schedule the task, within the calendar, into the two available hours identified within each of the five days located that have the available two hour time slot.

Within scheduling field 235, the system can display each time slot that has been scheduled for the task within the calendar of the user. Through interface 200, the user can view and edit each time slot scheduled for the task, e.g., each calendar event scheduled for the task. Upon editing one or more calendar events presented within scheduling field 235, the supplemental scheduling information contained within the task specification can be updated dynamically. In addition, each calendar event edited within scheduling field 235 can result in one or more time slots within the calendar of the user being rescheduled according to the calendar event edits entered via field 235.

Alternatively, the user can edit a calendar event corresponding to a task from directly within the calendar of the user. Responsive to the calendar update, the time slots presented for the task within scheduling field 235 can be altered to reflect the edits made to the calendar events for the task. Additionally, the supplemental scheduling information within the task specification, e.g., as presented within GUI 200, can be updated according to the calendar event updates. For example, if the last calendar event for the task is moved to a date that is later than Jun. 20, 2008, the due date of the task can be automatically altered to the date of the last calendar event for the task.

In one embodiment, the system can present a list of preferred time slots available within the calendar of the user in which to schedule the task. The user can either accept the preferred time slots for the task, or decline the preferred time slots and allow the system to select one or more replacement time slots. In yet another embodiment, the system can present a list of available time slots for the task from which the user can select one or more time slots to schedule the task. The user also may manually schedule time slots for the task if so desired.

Additionally, a user selection within preference field 240 of the option “Display tasks as free time” can cause the system to represent any calendar events scheduled for the task as free time to other users that may view the calendar of the user creating the task. For example, the user can select the check box within preference field 240 labeled “Display tasks as free time.” Upon the selection of the check box, each time slot reserved for the task within the calendar of the user will be presented to other users as empty, or unscheduled, slots of time.

Further, the user can specify scheduling preferences within preference field 240. In one embodiment, the user can select a box corresponding to either an A.M. scheduling preference or a P.M. scheduling preference within preferences field 240. The selection of one or the other of the boxes can express a user preference to schedule the task within either a morning or an afternoon time slot within the calendar. Using this approach, a variety of user scheduling preferences can be made selectable by the user. For example, the user can select a preference to schedule tasks on days without high priority meetings, to schedule the task on a particular day of the week, or to schedule the task on a day with low workloads, e.g., at least 6 available time slots in the day. The examples given for scheduling preferences are for illustration and description purposes, and, as a variety of user preferences can be implemented within preferences field 240, are not intended to limit the embodiments disclosed within this specification.

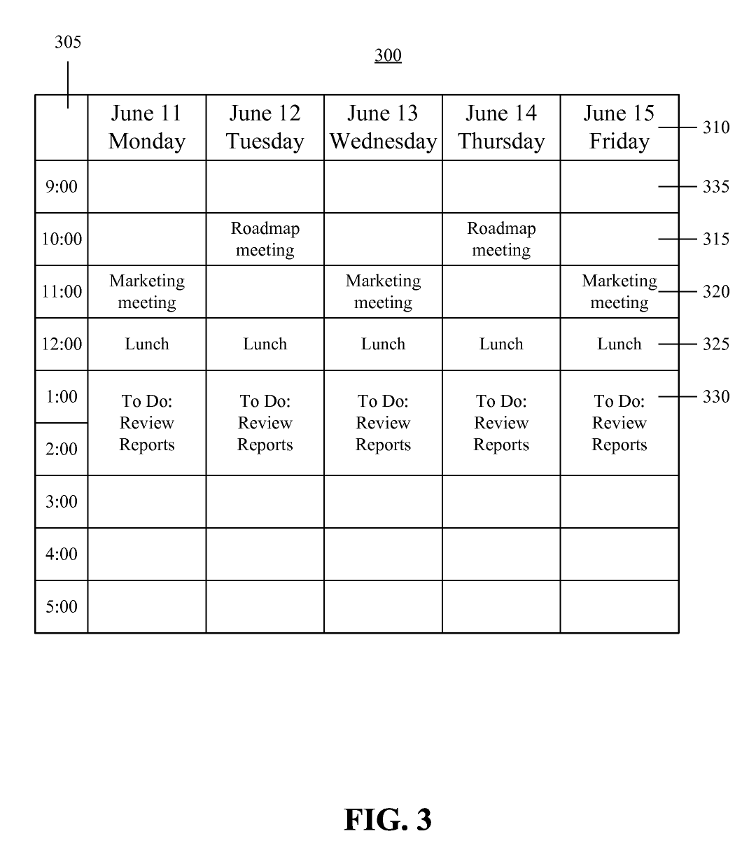

FIG. 3 is a second pictorial view illustrating a calendar 300 in which tasks and events are scheduled in accordance with another embodiment of the present invention. A system, as described with reference to FIG. 1, can render calendar 300 upon a display device communicatively linked to the system. Calendar 300 illustrates a case where a user input has specified a task. The specified task can include a due date and supplemental scheduling information.

Calendar 300 presents a weekly view of a calendar corresponding to the user specifying the task. Column 305 in calendar 300 lists a succession of one hour time slots associated with each day. Row 310 lists each day of a business week, e.g., Monday though Friday, whereby each column in calendar 300 represents a succession of one hour time slots associated with a particular day of the business week.

For example, a user desiring to specify a task “Review Reports” can define a task having a due date, e.g., June 15, and supplemental scheduling information corresponding to the task. The supplemental scheduling information can include a start date, e.g., June 11, a range of days to devote to the task, e.g., Monday through Friday, and a number of hours each day to devote to the task, e.g., two hours per day. Using the task due date and supplemental scheduling information, the system can search calendar 300 for contiguous two hour slots of time available each day of the range of days the user specified for the task.

As shown in FIG. 3, calendar 300 has events scheduled in rows 315, row 320, and row 325 of calendar 300, e.g., the 10:00 a.m.-12:00 p.m. time slots. As such, contiguous two hour slots of time for each day of the range of days specified for the task are not available until the 1:00 p.m. time slot in calendar 300. The system, having identified the 1:00 p.m. and 2:00 p.m. time slots as the first available contiguous two hour time slots for each day, can schedule the task within the 1:00 p.m. and 2:00 p.m. time slots of calendar 300. Row 315 in calendar 300 presents a succession of calendar events created and stored for the task “Review Reports” according to the due date and supplemental scheduling information input for the task.

The scheduling approach described in the preceding example has been presented for purposes of illustration and description and, as such, is not intended to limit the embodiments disclosed within this specification. Differing criteria, whether defined by the system or the user, can be used to determine one or more available slots of time within which to schedule the task. For example, the two hour slots of time assigned to the task “Review Reports” may not need to be contiguous. In illustration, the first one hour time slot specified for the task can be assigned to row 335, e.g., the 9:00 a.m. time slot, while the second hour can be scheduled at 1:00 p.m.

For example, the user can position a cursor over the 1:00 p.m. time slot in calendar 300. After selecting the time slot, for example, using the pointer device, the user can input a task description, “Review Reports,” and specify a two hour time slot for the task. The system then can create and store a calendar event for the task. The user can successively drag and drop the created calendar event over the 1:00 p.m.-2:00 p.m. time slots for each day the user specified to devote to the task, e.g., Tuesday through Friday. In this manner, the user can create the calendar events for the task presented in calendar 300.

As noted, calendar events created for the task can be considered free time when the calendar of the user is viewed by others. In this mode, only non-task calendar events will be displayed within the calendar of user when viewed by others. Calendar events scheduled for selected tasks will appear as available, e.g., unscheduled, time slots to other users. For example, the user can choose not to display calendar events associated with tasks in calendar 300. When viewed by users other than the user associated with calendar 300, calendar 300 will appear to have no events scheduled within the daily 10:00 a.m.-12:00 p.m. time slots scheduled for the task “Review Reports.” The 10:00 a.m.-12:00 p.m. time slots can appear to be available time slots within which other users can schedule events for the user.

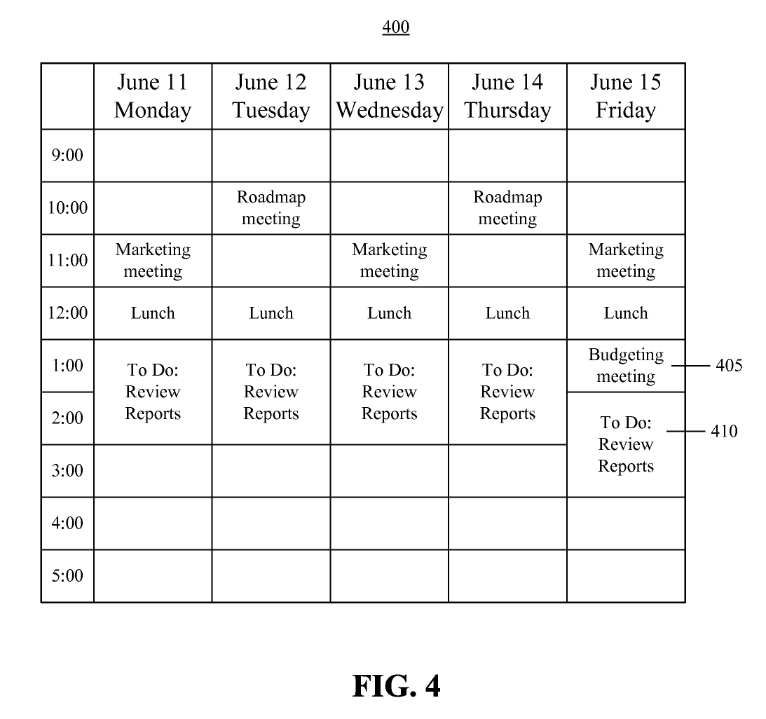

FIG. 4 is a third pictorial view illustrating a calendar 400 in which tasks are scheduled in accordance with another embodiment of the present invention. Calendar 400 illustrates the state of the calendar of FIG. 3 after a user input has accepted an invitation for a meeting that conflicts with a calendar entry created for the task specified described in FIG. 3.

Calendar event 405 can represent a calendar event created and stored within calendar 400 responsive to the user input accepting an invitation to a “Budgeting meeting” occurring during the Friday, 1:00 p.m. time slot. Calendar event 405 conflicts with a previously created calendar event in the 1:00 p.m. time slot for the task “Review Reports.” Upon detecting the calendar event conflict between the event and the task, the system can identify an available time slot for the task within calendar 400 and reschedule a calendar event for the task that was originally scheduled for 1:00 p.m.

Calendar event 410 can represent a calendar event created and stored by the system within an available time slot for the task identified by the system. With calendar event 405 having replaced the previously created calendar event in the 1:00 p.m. time slot for the task, the system can identify the 2:00 p.m. and the 3:00 p.m. time slots as the next available times slots for the task. Accordingly, the system can schedule, e.g., reschedule or move, the task to the identified 2:00 p.m. and the 3:00 p.m. time slots.

In one embodiment, tasks can be assigned a priority level. Responsive to a user accepting an event invitation that occurs during a time slot that conflicts with a previously created calendar event for a task whose priority level exceeds a priority level threshold, the system can present a notice to the user of the scheduling conflict between the task and the event. For example, the task, “Review Reports,” can have a priority level above a priority level threshold. Responsive to the user accepting an event invitation for the budgeting meeting in the 1:00 p.m. time slot of calendar 400, calendar event 405 can be created. Responsive to the system detecting a conflict between calendar event 405 and a previously created calendar event for the task, a notice can be presented alerting the user that a high priority task is being rescheduled. In one embodiment, the notice can present a list of available time slots, selectable by the user, within which the task can be rescheduled.

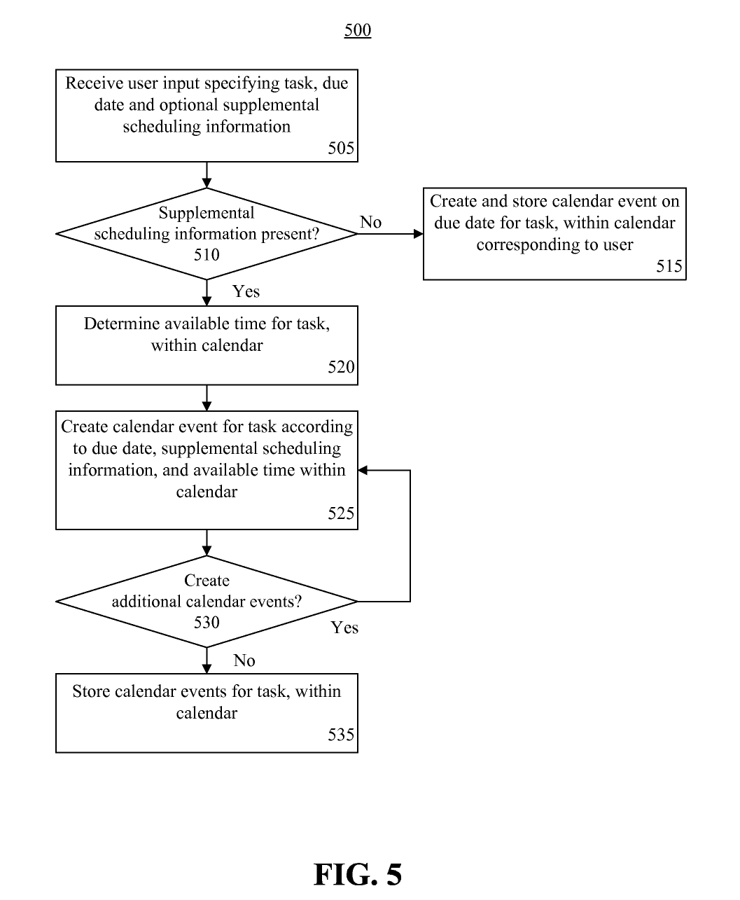

FIG. 5 is a first flow chart illustrating a method 500 of scheduling events within a calendar in accordance with another embodiment of the present invention. The method 500 can be implemented using a system as described with reference to FIGS. 1-4.

Beginning in step 505, the system can receive a user input specifying a task, including a due date for the task and optional supplemental scheduling information. In decision box 510, the system can determine whether the task being defined includes supplemental scheduling information. When supplemental scheduling information has been defined for the task, the method can proceed to step 520. When supplemental scheduling information is not defined for the task, the method can proceed to step 515.

In step 515, the system can create and store a calendar event corresponding to the task, on the due date for the task, within a calendar corresponding to the user. In this regard, a task can be created and a meeting can be created for the task. The meeting will be associated with the task within the system so that modification of one, e.g., the task or the meeting corresponding to the task, will cause modification of the other. In one embodiment, as an alternative to creating a calendar event for the task with no supplement scheduling information, the system can present the task within the calendar corresponding to the user on the due date of the task. In this approach, the task is not scheduled, e.g., no time slot is reserved for the task within the calendar of the user, rather text describing the task can appear within the calendar corresponding to the user on the due date for the task.

In step 520, the system can determine available time for the task, within the calendar. Using criteria established by the system or the user, the system can determine which of one or more slot(s) of time is available within the calendar to meet the scheduling requirements for the task according to the task due date and the supplemental scheduling information.

In step 525, the system can create a calendar event for the task according to the task due date, the supplemental scheduling information, and the one or more available slot(s) of time within the calendar.

In decision step 530, the system can determine whether to create additional calendar events for the task according to the supplemental scheduling information. For example, if the task requires 20 hours of time to complete, and the meetings scheduled for the task are limited to two hours, the method will schedule 10 different meetings for the task. When additional calendar events for the task are to be created, the method can return to step 525. When additional calendar events for the task are not to be created, the method can continue to step 535.

In step 535, the system can store the created calendar events for the task, within the calendar within memory of the system. As discussed, though the calendar events created for a task can be maintained independently of that task, an association between each calendar event and the task can be maintained. Accordingly, any updates to the task can result in the system dynamically changing any calendar events relating to the task. Similarly, changing a calendar event for a task can result in the system dynamically changing information for the related task. If, for example, a user changes a due date on a task to a later date, the system can reschedule meetings for the task over the newly defined time period. Similarly, if the user changes the last calendar event to a later date, the due date of the corresponding task can be automatically changed.

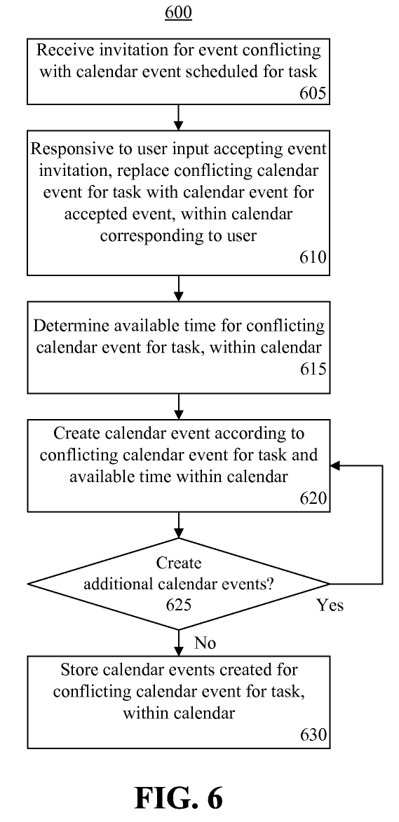

FIG. 6 is a second flow chart illustrating a method 600 of scheduling events within a calendar in accordance with another embodiment of the present invention. The method 600 can be implemented using a system as described with reference to FIGS. 1-5.

Beginning in step 605, the system can receive an invitation for an event whose scheduling conflicts with a calendar event previously scheduled for a task. In step 610, responsive to user input accepting the event invitation, the system can replace the conflicting calendar event for the scheduled task with a calendar event for the accepted event (invitation), within a calendar corresponding to the user. It should be appreciated that the conflicting and accepted event can conflict with all or a portion of the calendar event previously scheduled for the task. When only a portion of the calendar event previously scheduled for the task conflicts with the accepted event, the calendar event for task can be modified or shifted in time if time is available within the user calendar so that such a time shift does not cause a further conflict.

In another embodiment, the calendar event for the task can be split into two or more different calendar events. The portion of the calendar event for the task that did not conflict with the newly scheduled meeting can be left intact. The portion of the calendar event for the task that did conflict can be rescheduled.

In step 615, the system can determine available time for the conflicting calendar event for the task within the calendar corresponding to the user. Using criteria established by the system or the user, the system can determine which of one or more slot(s) of time is available within the calendar to meet the scheduling requirements for the task according to the task due date and the supplemental scheduling information. In step 620, the system can create a calendar event according to the time required for the conflicting calendar event and available time for the task within the calendar.

In decision box 625, the system can determine whether to create additional calendar events for the task according to the time required for the conflicting calendar event and available time within the calendar corresponding to the user. When additional calendar events for the task are to be created, the method can return to step 620. For example, a two hour calendar event for the task can be split into two one calendar events if a two hour time slot is not available. When additional calendar events for the task are not to be created, the method can continue to step 635.

In step 635, the system can store calendar events created for the conflicting calendar event for the scheduled task, within the calendar.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of task scheduling, the method comprising:
receiving an input from a user, wherein the input specifies a task comprising a date;
determining whether the task comprises supplemental scheduling information;
when the task does not comprise supplemental scheduling information, creating and storing, within memory, a first calendar event corresponding to the task within a calendar of the user scheduled on the date; and
when the task does comprise supplemental scheduling information, creating and storing, within memory, at least a first calendar event corresponding to the task within a calendar of the user scheduled according to the date and the supplemental scheduling information.

2. The computer-implemented method of claim 1, wherein the task comprises supplemental scheduling information comprising a number of days and a number of hours assigned to the task, the method further comprising creating and storing a plurality of calendar events corresponding to the task within the calendar of the user scheduled according to the date, the number of days, and the number of hours assigned to the task.

3. The computer-implemented method of claim 1, further comprising responsive to scheduling a second calendar event that is not associated with a task and that conflicts with the first calendar event, rescheduling at least a portion of the first calendar event that conflicts with the second calendar event.

4. The computer-implemented method of claim 3, wherein rescheduling at least a portion of the first calendar event that conflicts with the second calendar event further comprises:
determining an alternative time slot to reschedule the first calendar event; and
rescheduling at least a portion of the first calendar event in the alternative time slot.

5. The computer-implemented method of claim 1, further comprising visually distinguishing each calendar event that is generated from a task from calendar events that are not generated from a task upon a display.

6. The computer-implemented method of claim 1, further comprising:
receiving a user input requesting a hold in scheduling any calendar event corresponding to the task; and
only scheduling a calendar event for the task responsive to a further user input releasing the hold.

7. The computer-implemented method of claim 1, further comprising:
assigning a priority level to each of a plurality of tasks; and
scheduling each of the plurality of task, within the calendar of the user, according to the priority level of the task, wherein higher priority tasks are scheduled before lower priority tasks.

8. The computer-implemented method of claim 7, further comprising responsive to receiving an invitation to a second calendar event that conflicts with the first calendar event, wherein the first calendar event is a high priority event, notifying the user that at least a portion of the first calendar event that conflicts with the second calendar event is being rescheduled by accepting the invitation.

9. A system for performing task scheduling comprising:
a memory comprising computer-usable program code;
a processor, executing the computer-usable program code, wherein the processor:
receives an input from a user, wherein the input specifies a task comprising a date;
determines whether the task comprises supplemental scheduling information;
when the task does not comprise supplemental scheduling information, creates and stores, within memory, a first calendar event corresponding to the task within a calendar of the user scheduled on the date within memory; and
when the task does comprise supplemental scheduling information, creates and stores, within memory, at least a first calendar event corresponding to the task within a calendar of the user scheduled according to the date and the supplemental scheduling information.

10. The system of claim 9, wherein the task comprises supplemental scheduling information comprising a number of days and a number of hours assigned to the task, wherein the processor creates and stores a plurality of calendar events corresponding to the task within the calendar of the user scheduled according to the date, the number of days, and the number of hours assigned to the task.

11. The system of claim 9, wherein the processor, responsive to scheduling a second calendar event that is not associated with a task and that conflicts with the first calendar event, reschedules at least a portion of the first calendar event that conflicts with the second calendar event

12. The system of claim 9, wherein the processor visually distinguishes each calendar event that is generated from a task from calendar events that are not generated from a task upon a display.

13. The system of claim 9, wherein the processor:
receives a user input requesting a hold in scheduling any calendar event corresponding to the task; and
only schedules a calendar event for the task responsive to a further user input releasing the hold.

14. The system of claim 9, wherein the processor:
assigns a priority level to each of a plurality of tasks; and
schedules each of the plurality of task, within the calendar of the user, according to the priority level of the task, wherein higher priority tasks are scheduled before lower priority tasks.

15. A computer program product comprising:
a computer-usable medium comprising computer-usable program code that, when executed by a computer, schedules tasks, the computer-usable medium comprising:
computer-usable program code that receives an input from a user, wherein the input specifies a task comprising a date;
computer-usable program code that determines whether the task comprises supplemental scheduling information;
computer-usable program code that, when the task does not comprise supplemental scheduling information, creates and stores, within memory, a first calendar event corresponding to the task within a calendar of the user scheduled on the date; and
computer-usable program code that, when the task does comprise supplemental scheduling information, creates and stores, within memory, at least a first calendar event corresponding to the task within a calendar of the user scheduled according to the date and the supplemental scheduling information.

16. The computer program product of claim 15, wherein the task comprises supplemental scheduling information comprising a number of days and a number of hours assigned to the task, the computer-usable medium further comprising computer-usable program code that creates and stores a plurality of calendar events corresponding to the task within the calendar of the user scheduled according to the date, the number of days, and the number of hours assigned to the task.

17. The computer program product of claim 15, the computer-usable medium further comprising computer-usable program code that, responsive to scheduling a second calendar event that is not associated with a task and that conflicts with the first calendar event, reschedules at least a portion of the first calendar event that conflicts with the second calendar event.

18. The computer program product of claim 17, wherein computer-usable program code that reschedules at least a portion of the first calendar event that conflicts with the second calendar event further comprises:
computer-usable program code that determines an alternative time slot to reschedule the first calendar event; and
computer-usable program code that reschedules at least a portion of the first calendar event in the alternative time slot.

19. The computer program product of claim 15, the computer-usable medium further comprising computer-usable program code that visually distinguishes each calendar event that is generated from a task from calendar events that are not generated from a task upon a display.

20. The computer program product of claim 15, the computer-usable medium further comprising:
computer-usable program code that receives a user input requesting a hold in scheduling any calendar event corresponding to the task; and
computer-usable program code that only schedules a calendar event for the task responsive to a further user input releasing the hold.
